(19) United States
(12) Patent Application Publication
(10) Pub. No.: US 2009/0064846 A1
(43) Pub. Date: Mar. 12, 2009

(54) METHOD AND APPARATUS FOR GENERATING AND READING BAR CODED SHEET MUSIC FOR USE WITH MUSICAL INSTRUMENT DIGITAL INTERFACE (MIDI) DEVICES

(75) Inventor: Christopher AUCLAIR, Webster, NY (US)

Correspondence Address: Prass LLP, 2661 Riva Road, Building 1000, Suite 1044, Annapolis, MD, 21401, US

(73) Assignee: XEROX CORPORATION, Stamford, CT (US)

(21) Appl. No.: 11/852,363

(22) Filed: Sep. 10, 2007

(51) Int. Cl. G09B 15/00; G06K 7/10

(52) U.S. Cl. 84/483.1; 235/462.01

(57) ABSTRACT

This disclosure concerns a method and apparatus that generates bar coded sheet music for use with Musical Instrument Digital Interface (MIDI) devices. The method may include receiving sheet music data, converting the sheet music data to MIDI data, encoding the MIDI data to bar code data, and outputting bar coded sheet music.

### BACKGROUND

1. Field of the Disclosure

This disclosure concerns generating bar coded sheet music for use with Musical Instrument Digital Interface (MIDI) devices.

2. Introduction

The Musical Instrument Digital Interface (MIDI) protocol has been widely accepted and utilized by musicians and composers since its introduction in the early 1980's. MIDI data represents computer programmed musical performance information which specifies time, key and strength of stroke, for example, and send the signal to a musical instrument.

For the past several years, many pianos have been equipped with both factory installed and aftermarket MIDI file readers and player bars. These systems allow pianos to read optical or magnetic media with MIDI data. For example, MIDI data may be sent player bars within the piano, which comprise 88 solenoid driven actuators, one for each piano key. These file readers typically utilize preprogrammed floppy disks and/or CDs, created by the reader manufacturers and are both limited in performance material and expensive (costing $25-60, for a single CD). The vast majority of music available on sheet music is not available on these CDs.

### SUMMARY

This disclosure concerns a method and apparatus that generates bar coded sheet music for use with Musical Instrument Digital Interface (MIDI) devices. The method may include receiving sheet music data, converting the sheet music data to MIDI data, encoding the MIDI data to bar code data, and outputting bar coded sheet music.

### BRIEF DESCRIPTION OF THE DRAWINGS

FIG. 1 illustrates a diagram of an exemplary bar coded sheet music generation system in accordance with embodiments of the disclosure;

FIG. 2 illustrates a block diagram of an exemplary bar coded sheet music generator in accordance with embodiments of the disclosure;

FIG. 3 illustrates a diagram of an exemplary bar coded sheet music reader in accordance with embodiments of the disclosure;

FIG. 4 illustrates a diagram of an exemplary bar coded sheet music reading system in accordance with embodiments of the disclosure;

FIG. 5 illustrates a flowchart of an exemplary bar coded sheet music generation process in accordance with embodiments of the disclosure; and

FIG. 6 illustrates a flowchart of an exemplary bar coded sheet music reading process in accordance with embodiments of the disclosure.

### DETAILED DESCRIPTION

Aspects of the embodiments disclosed herein relate to methods for generating bar coded sheet music for use with Musical Instrument Digital Interface (MIDI) devices, a corresponding apparatus, and an apparatus that reads the bar coded sheet music. The disclosed embodiments concern a method and apparatus that will allow music publishers to print sheet music with bar codes that will be readable by a proposed proprietary barcode reader that the end user could mount on or near a musical instrument, such as a piano. Sheet music with the proposed bar coded MIDI data would then be passed through the reader and be played in real time by the piano through the MIDI playing system.

The disclosed embodiments may include a method for generating bar coded sheet music for use with Musical Instrument Digital Interface (MIDI) devices. The method may include receiving sheet music data, converting the sheet music data to MIDI data, encoding the MIDI data to bar code data, associating the bar code data to the sheet music data, and outputting bar coded sheet music.

The disclosed embodiments may further include an apparatus that generates bar coded sheet music for use with MIDI devices. The apparatus may include a MIDI data converter that receives sheet music data and converts the sheet music data to MIDI data, an encoder that encodes the MIDI data to bar code data, and an output device that associates the bar code data to the sheet music data and outputs bar coded sheet music.

The disclosed embodiments may further include an apparatus that reads bar coded sheet music for use with MIDI devices. The apparatus may include a MIDI interface, and a bar coded sheet music reader that reads bar coded data, converts the bar coded data to MIDI data, and outputs the MIDI data to a MIDI device using the MIDI interface.

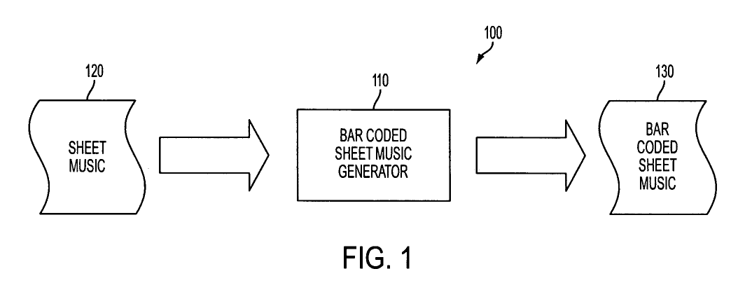

FIG. 1 illustrates a diagram of an exemplary bar coded sheet music generation system 100 in accordance with embodiments of the disclosure. The bar coded sheet music generation system 100 may include a bar coded sheet music generator 110 that may take ordinary sheet music 120 and generate bar coded sheet music 130 containing MIDI data. The bar coded sheet music 130 may then be used as an input to a MIDI reading and/or playing device.

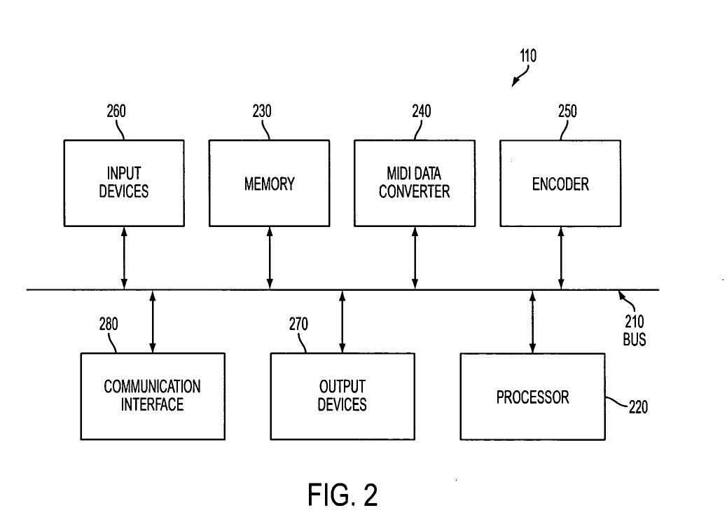

FIG. 2 illustrates a block diagram of an exemplary bar coded sheet music generator 110 in accordance with embodiments of the disclosure. The bar coded sheet music generator 110 may be embodied within devices such as a desktop computer, a laptop computer, a handheld computer, a handheld communication device, or another type of computing device, or the like. The bar coded sheet music generator 110 may include a bus 210, processor 220, memory 230, MIDI data converter 240, encoder 250, input devices 260, output devices 270, and communication interface 280. The bus 210 may permit communication and transfer of signals among the components of the bar coded sheet music generator 110.

Processor 220 may include at least one conventional processor or microprocessor that interprets and executes instructions. The processor 220 may be a general purpose processor or a special purpose integrated circuit, such as an ASIC, and may include more than one processor section. Additionally, the bar coded sheet music generator 110 may include a plurality of processors 220.

Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220. The memory 230 may be any memory device that stores data for use by the bar coded sheet music generator 110.

Input devices 140 may include one or more conventional input mechanisms that permit a user to input information to the bar coded sheet music generator 110, such as a microphone, touchpad, keypad, keyboard, mouse, pen, stylus, voice recognition device, buttons, and the like, and/or interfaces for the above. Output devices 270 such as one or more conventional mechanisms that output information to the user, including a display, one or more speakers, a storage medium, such as a memory, magnetic or optical disk, disk drive, a printer device, and the like, and/or interfaces for the above.

Communication interface 280 may include any mechanism that facilitates communication via one or more communications network. For example, communication interface 280 may include a modem. Alternatively, communication interface 280 may include other mechanisms in communicating with other devices and/or systems via wireless connections.

The bar coded sheet music generator 110 may perform functions in response to processor 220 by executing sequences of instructions or instruction sets contained in a computer-readable medium, such as, for example, memory 230. Such instructions may be read into memory 230 from another computer-readable medium, such as a storage device, or from a separate device via a communication interface, or may be downloaded from an external source such as the Internet. The bar coded sheet music generator 110 may be a stand-alone system, such as a personal computer, or may be connected to a network such as an intranet, the Internet, and the like. Other elements may be included with the bar coded sheet music generator 110 as needed.

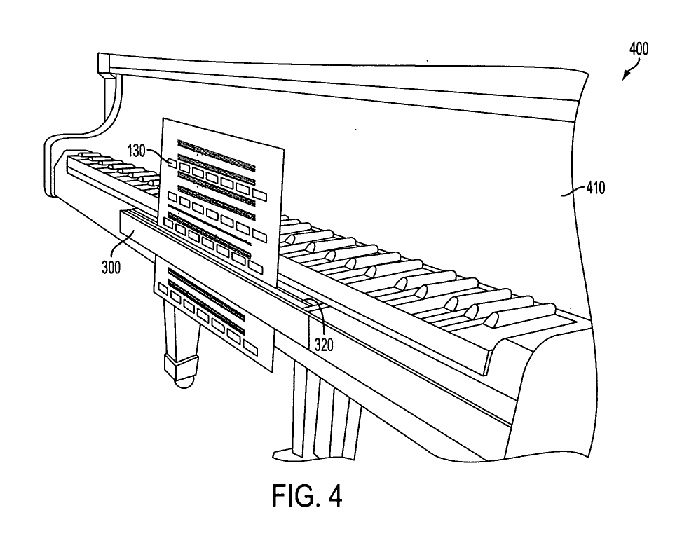

Note that while the MIDI data converter 240 and the encoder 250 are shown as separate elements, any or all of their functions may be performed by the processor 220. The operation of the encoder 250 and the MIDI data converter 240 will be discussed below in relation to the discussion concerning FIG. 4.

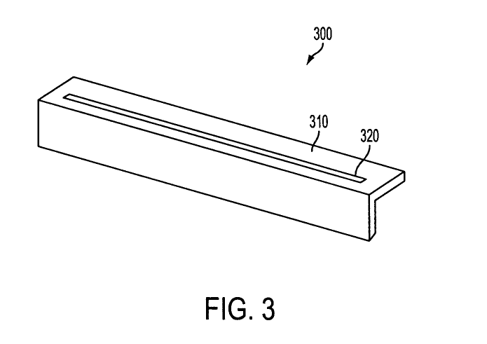

FIG. 3 illustrates a diagram of an exemplary bar coded sheet music reader 300 in accordance with embodiments of the disclosure. The bar coded sheet music reader 300 may include a reader body 310 and a slot 320 for the input of sheet music. The bar coded sheet music reader 300 may rest on or near a musical instrument or other music playing device. The bar coded sheet music reader 300 may include a scanner or any other device capable of reading bar codes, such as a wand, for example. The bar coded sheet music reader 300 may include a MIDI interface to facilitate coupling to and communicating with MIDI devices. A MIDI device may be any device capable of receiving and processing MIDI data, including a musical instrument, a synthesizer, a MIDI sound module, a MIDI reader, and a MIDI sequencer. There may also be a WIFI connection between the reader and the MIDI sequencer.

FIG. 4 illustrates a diagram of an exemplary bar coded sheet music reading system 400 in accordance with embodiments of the disclosure. In this example, the bar coded sheet music reader 300 rests on the edge of piano 410. Bar coded sheet music 130 is fed from the top of the bar-coded sheet music reader 300 through slot 320. The bar coded sheet music reader 300 may convert the bar codes to MIDI data and the piano 410 recognizes the MIDI data and plays the music.

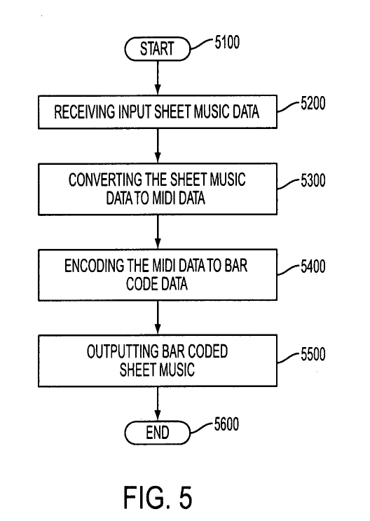

FIG. 5 illustrates a flowchart of an exemplary bar coded sheet music generation process in accordance with embodiments of the disclosure. The method starts at 5100, and continues to 5200 where the MIDI data converter 240 may receive the sheet music data. The sheet music data may be received in paper or electronic form, such as from a USB, CD or DVD, for example. At step 5300, the MIDI data converter 240 may convert the sheet music data to MIDI data. In this manner, the MIDI data converter 240 may convert the sheet music to MIDI data using any known conversion algorithm. The MIDI data may include musical note events, such as timing, stroke, duration, and impact strength.

At 5400, the encoder 250 may encode the MIDI data to bar code data. The bar code data may be encoded in any bar code format known to one of skill in the art, including PDF417 & Macro PDF417, PDF417 Truncated, Maxicode, DataMatrix, QRCode, UCC EAN RSS 14 Stacked, UCC EAN RSS 14 Stacked Omni directional, and UCC EAN RSS Expanded Stacked.

The output device 270 may associate the bar code data to the sheet music data. In this manner, the bar codes are configured to properly correspond to the printed sheet music. For example, the associated bar code may be printed directly above or below the corresponding music notes. At step 5500, the output device 270 may output the bar coded sheet music. The output device 270 may be any device that can print sheet music, such as a printer, or assist in the printing of sheet music such as a memory device. The process then goes to step 5600 and ends. Note that for long printed musical compositions, the bar codes may be consolidated onto a single page that is supplied loose leaf from the rest of the music to facilitate sending through a reader.

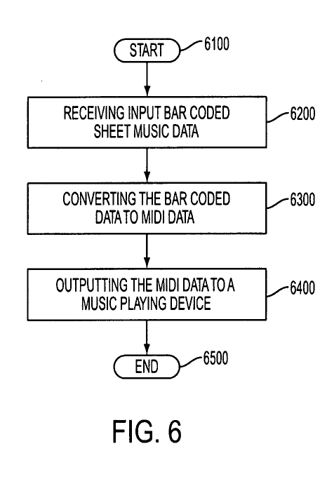

FIG. 6 illustrates a flowchart of an exemplary bar coded sheet music reading process in accordance with embodiments of the disclosure. The process starts at 6100, and continues to 6200 where the bar coded sheet music reader 300 reads bar coded data using any bar code reading device known to one of skill in the art, such as a scanner. At step 6300, the bar coded sheet music reader 300 converts the bar coded data to MIDI data using any known MIDI data conversion algorithm. At step 6400, the bar coded sheet music reader 300 outputs the MIDI data to a MIDI device using a MIDI interface. The process then goes to step 6500 and ends.

Embodiments as disclosed may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hard wired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of generating bar coded sheet music for use with Musical Instrument Digital Interface (MIDI) devices, comprising:
receiving sheet music data;
converting the sheet music data to MIDI data;
encoding the MIDI data to bar code data;
outputting bar coded sheet music,
wherein the bar coded sheet music is fed by a user to a bar coded sheet music reader coupled to a musical instrument, the bar coded sheet music reader reads the bar coded data, converts the bar coded data to MIDI data, and outputs the MIDI data to a MIDI device which is connected to a musical instrument that the generates music represented by the sheet music data.

2. The method of claim 1, wherein the bar coded sheet music is capable of being read by a MIDI device.

3. The method of claim 2, wherein the MIDI devices may be one of a musical instrument, a synthesizer, a MIDI sound module, a MIDI reader, and a MIDI sequencer.

4. The method of claim 1, wherein the bar code data may be at least one of PDF 417 & Macro PDF417, PDF417 Truncated, Maxicode, DataMatrix, QRCode, UCC LAN RSS 14 Stacked, UCC LAN RSS 14 Stacked Omni directional, and UCC LAN RSS Expanded Stacked.

5. The method of claim 1, wherein the MIDI data includes musical note events.

6. The method of claim 5, wherein the musical note events are at least one of timing, stroke, duration, and impact strength.

7. The method of claim 1, wherein the bar coded sheet music is printed on paper.

8. An apparatus that generates bar coded sheet music for use with Musical Instrument Digital Interface (MIDI) devices, comprising:
a MIDI data converter that receives sheet music data and converts the sheet music data to MIDI data;
an encoder that encodes the MIDI data to bar code data; and
an output device that outputs bar coded sheet music,
wherein the bar coded sheet music is fed by a user to a bar coded sheet music reader coupled to a musical instrument, the bar coded sheet music reader reads the bar coded data, converts the bar coded data to MIDI data, and outputs the MIDI data to a MIDI device which is connected to a musical instrument that the generates music represented by the sheet music data.

9. The apparatus of claim 8, wherein the bar coded sheet music is capable of being read by a MIDI device.

10. The apparatus of claim 9, wherein the MIDI devices may be one of a musical instrument, a synthesizer, a MIDI sound module, a MIDI reader, and a MIDI sequencer.

11. The apparatus of claim 8, wherein the bar code data may be at least one of PDF 417 & Macro PDF417, PDF417 Truncated, Maxicode, DataMatrix, QRCode, UCC LAN RSS 14 Stacked, UCC LAN RSS 14 Stacked Omni directional, and UCC LAN RSS Expanded Stacked.

12. The apparatus of claim 8, wherein the MIDI data includes musical note events.

13. The apparatus of claim 12, wherein the musical note events are at least one of timing, stroke, duration, and impact strength.

14. The apparatus of claim 8, wherein the output device includes a printer that prints the bar coded sheet music onto paper.

15. An apparatus that reads bar coded sheet music for use with Musical Instrument Digital Interface (MIDI) devices, comprising:
a MIDI interface; and
a bar coded sheet music reader coupled to a musical instrument, wherein the bar coded sheet music reader reads the bar coded data, converts the bar coded data to MIDI data, and outputs the MIDI data to a MIDI device using the MIDI interface, and the MIDI device is connected to a musical instrument that the generates music represented by the sheet music data.

16. The apparatus of claim 15, wherein the MIDI device may be one of a musical instrument, a synthesizer, a MIDI sound module, a MIDI reader, and a MIDI sequencer.

17. The apparatus of claim 15, wherein the bar code data may be at least one of PDF 417 & Macro PDF417, PDF417 Truncated, Maxicode, DataMatrix, QRCode, UCC LAN RSS 14 Stacked, UCC LAN RSS 14 Stacked Omni directional, and UCC LAN RSS Expanded Stacked.

18. The apparatus of claim 15, wherein the MIDI data includes musical note events.

19. The apparatus of claim 18, wherein the musical note events are at least one of timing, stroke, duration, and impact strength.

20. The apparatus of claim 15, wherein the bar coded sheet music reader is coupled to a piano.
